(19) United States
(12) Patent Application Publication
(10) Pub. No.: US 2023/0368760 A1
(43) Pub. Date: Nov. 16, 2023

(54) AUDIO ANALYSIS SYSTEM, ELECTRONIC MUSICAL INSTRUMENT, AND AUDIO ANALYSIS METHOD

(71) Applicant: YAMAHA CORPORATION, Hamamatsu-shi (JP)

(72) Inventors: Masafumi SOBAJIMA, Hamamatsu-shi (JP); Dan SASAI, Hamamatsu-shi (JP)

(21) Appl. No.: 18/360,937

(22) Filed: Jul. 28, 2023

Related U.S. Application Data
(63) Continuation of application No. PCT/JP22/02232, filed on Jan. 21, 2022.

(30) Foreign Application Priority Data
Feb. 5, 2021 (JP) 2021-017465

(51) Int. Cl. G10H 1/40

(52) U.S. Cl. CPC G10H 1/40; G10H 2250/311; G10H 2210/056

(57) ABSTRACT

An audio analysis system includes at least one memory configured to store instructions; and at least one processor configured to execute the instructions to: receive an instruction indicative of a target timbre; acquire a first audio signal containing a plurality of audio components corresponding to different timbres; and select at least one reference signal from among a plurality of reference signals respectively representative of different pieces of audio based on the target timbre and the first audio signal, in which: the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

### CROSS REFERENCE TO RELATED APPLICATIONS

This application is a Continuation Application of PCT Application No. PCT/JP2022/002232, filed on Jan. 21, 2022, and is based on, and claims priority from, Japanese Patent Application No. 2021-017465, filed on Feb. 5, 2021, the entire contents of which are incorporated herein by reference.

### BACKGROUND

### Technical Field

This disclosure relates to a technique for analyzing an audio signal.

### Background Information

There have been proposed techniques for analyzing a feature of an audio signal representative of audio of a piece of music. International Publication WO 2020/166094 discloses a technique for automatically creating a piece of music using a machine learning technique. When a user creates a piece of music or practices playing a musical instrument, the user may wish to use a pattern similar to a repeated pattern with a particular timbre in audio of a particular piece of music. However, for a user to find a pattern considerable effort and musical knowledge may be required on behalf of the user. Accordingly, it may be difficult for the user to find the pattern.

### SUMMARY

An object of one aspect of this disclosure is to reduce an effort required by a user to find a pattern that is played with a particular timbre.

In one aspect, an audio analysis system includes at least one memory configured to store instructions and at least one processor configured to execute the instructions to: receive an instruction indicative of a target timbre; acquire a first audio signal containing a plurality of audio components corresponding to different timbres; and select at least one reference signal from among a plurality of reference signals respectively representative of different pieces of audio based on the target timbre and the first audio signal, in which: the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

In another aspect, an electronic musical instrument includes at least one memory configured to store instructions and at least one processor configured to execute the instructions to: receive an instruction indicative of a target timbre; acquire a first audio signal containing a plurality of audio components corresponding to different timbres; select at least one reference signal from among a plurality of reference signals respectively representative of different pieces of audio based on the target timbre and the first audio signal, and cause a playback system to emit a sound represented by the at least one reference signal and to emit a sound corresponding to a playing of a piece of music by a user, in which: the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

In yet another aspect, a computer-implemented audio analysis method includes receiving an instruction indicative of a target timbre; acquiring a first audio signal containing a plurality of audio components corresponding to different timbres; and selecting at least one reference signal from among a plurality of reference signals respectively representative of different pieces of audio based on the target timbre and the first audio signal, in which the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

### BRIEF DESCRIPTION OF THE DRAWINGS

FIG. 1 is a block diagram showing a configuration of an electronic musical instrument according to a first embodiment.

FIG. 2 is a block diagram showing a functional configuration of the electronic musical instrument.

FIG. 3 is a block diagram showing a configuration of an audio analyzer.

FIG. 4 is a diagram showing a separator.

FIG. 5 is a diagram showing an analysis rhythm pattern.

FIG. 6 is a flowchart showing a processing procedure to generate the analysis rhythm pattern.

FIG. 7 is a diagram showing an operation of a selector.

FIG. 8 is a schematic diagram showing an analysis image.

FIG. 9 is a schematic diagram showing another analysis image.

FIG. 10 is a flowchart showing an audio analysis processing procedure.

FIG. 11 is a block diagram showing a configuration of an information processing system.

FIG. 12 is a block diagram showing a functional configuration of the information processing system.

FIG. 13 is a flowchart showing a processing procedure by which a controller of the information processing system establishes a trained model by machine learning.

FIG. 14 is a diagram showing generation of a basis matrix by the information processing system.

FIG. 15 is a diagram showing generation of reference rhythm patterns by the information processing system.

FIG. 16 is a block diagram showing a configuration of the audio analyzer according to a second embodiment.

FIG. 17 is a flowchart showing the audio analysis processing procedure according to the second embodiment.

FIG. 18 is a diagram showing the selector according to a third embodiment.

FIG. 19 is a block diagram showing a configuration of a playing system according to a fourth embodiment.

FIG. 20 is a diagram showing the selector according to a fifth embodiment.

FIG. 21 is a block diagram showing a configuration of a trained model.

FIG. 22 is a flowchart showing the audio analysis processing procedure according to the fifth embodiment.

FIG. 23 is a block diagram showing a functional configuration of the information processing system according to the fifth embodiment.

FIG. 24 is a block diagram showing a configuration of the playing system according to a sixth embodiment.

### DETAILED DESCRIPTION

### A: First Embodiment

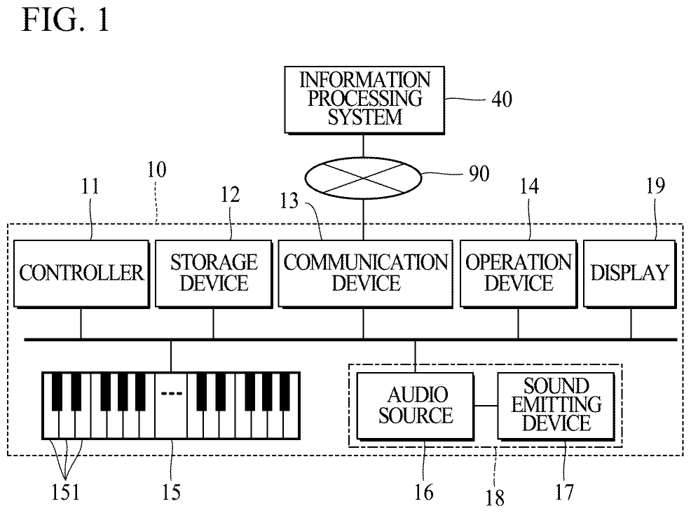

FIG. 1 is a block diagram showing a configuration of an electronic musical instrument 10 according to a first embodiment. The electronic musical instrument 10 is an audio analysis system configured to implement not only a function of emitting a sound in accordance with a playing of a piece of music by a user, but also a function of analyzing an audio signal S1 representative of audio of a particular piece of music. The audio of the particular piece of music may be instrumental audio.

The electronic musical instrument 10 includes a controller 11, a storage device 12, a communication device 13, an operation device 14, a playing input device 15, an audio source 16, a sound emitting device 17, and a display 19. The electronic musical instrument 10 may be constituted of a single integrated device, or may be constituted of a plurality of separate devices.

The controller 11 is constituted of one or more processors configured to control components of the electronic musical instrument 10. The controller 11 may be constituted of one or more types of processors such as a central processing unit (CPU), a sound processing unit (SPU), a digital signal processor (DSP), a field programmable gate array (FPGA), or an application specific integrated circuit (ASIC).

The storage device 12 includes one or more memories configured to store a program executed by the controller 11 and a variety of types of data used by the controller 11. The storage device 12 may be constituted of a known recording medium such as a magnetic recording medium or a semiconductor recording medium. Alternatively the storage device 12 may be constituted of a combination of different types of recording media. The storage device 12 may be a portable recording medium that is detachable from the electronic musical instrument 10, or may be a recording medium (for example, a cloud storage server) that is accessible by the controller 11 via a communication network 90.

The storage device 12 stores the audio signal S1 that is to be analyzed by the electronic musical instrument 10. The audio signal S1 is a signal that includes a plurality of audio components of sound emitted from different musical instruments. The audio signal S1 may include audio components of sound emitted from one or more singers. The audio signal S1 may be included in a music file. The music file is delivered from a music distribution device (not shown) to the electronic musical instrument 10. The music file is stored in the storage device 12. The audio signal S1 is an example of a “first audio signal.” A reproduction device, which reads the audio signal S1 from a recording medium such as an optical disk, may provide the read audio signal S1 to the electronic musical instrument 10.

The communication device 13 communicates with other devices via the communication network 90. The communication device 13 may communicate with an information processing system 40 described below. A communication link between the communication device 13 and the communication network 90 may or may not include a wireless section. The communication device 13 may be provided separate from the electronic musical instrument 10. The communication device 13 provided separate from the electronic musical instrument 10 may be an information terminal device such as a smartphone or a tablet terminal.

The operation device 14 is an input device configured to receive instructions from the user. The operation device 14 may be constituted of a plurality of elements operable by the user, or may be constituted of a touch panel that detects contact made by the user. The user can operate the operation device 14 to provide the electronic musical instrument 10 with an instruction indicative of a desired musical instrument (hereinafter, referred to as a “target musical instrument”) among a plurality of types of musical instruments. Different musical instruments produce different timbres. Thus, the instruction provided by the user indicative of the target musical instrument is an example of an “instruction indicative of a timbre.” Furthermore, the target musical instrument is an example of a “target timbre.”

The playing input device 15 is a device configured to receive input from the user in playing a piece of music. The playing of the piece of music may include playing of the piece of music on the electronic musical instrument 10. Alternatively, the playing of the piece of music may include singing by a singer of the piece of music. The playing input device 15 includes a keyboard that has a plurality of keys 151 each of which corresponds to a different pitch, for example. The user plays the piece of music by operating (in a sequence) the keys 151. As described above, an example of the electronic musical instrument 10 is an electronic keyboard musical instrument.

The audio source 16 generates an audio signal upon operation of the playing input device 15 by the user U. The audio source 16 generates an audio signal representative of audio with a timbre that corresponds to one of the keys 151 operated by the user. The controller 11 may execute the program stored in the storage device 12 to implement the functions of the audio source 16. In this case, the audio source 16 may be omitted.

The sound emitting device 17 emits a sound based on the audio with the timbre represented by the audio signal generated by the audio source 16. The sound emitting device 17 may be a loudspeaker or headphones. The audio source 16 and the sound emitting device 17 according to the first embodiment function as a playback system 18 configured to emit a sound in accordance with the playing of the piece of music by the user. The display 19 displays images under control of the controller 11. The display 19 may be a liquid crystal display panel, for example.

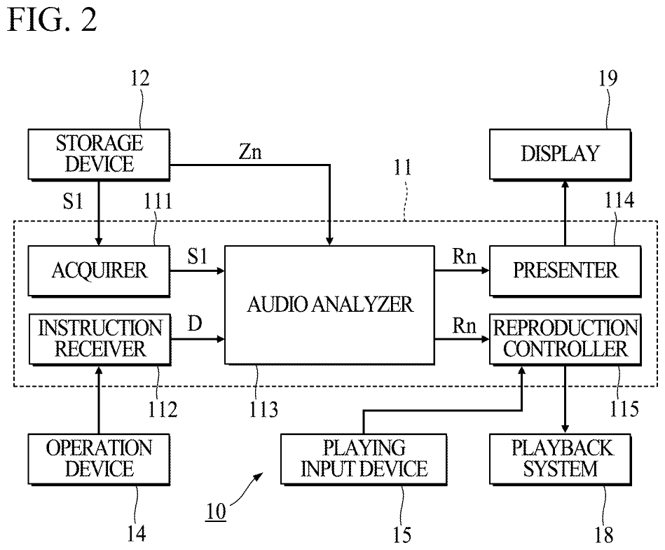

FIG. 2 is a block diagram showing a functional configuration of the electronic musical instrument 10. The controller 11 of the electronic musical instrument 10 executes the program stored in the storage device 12 to implement a plurality of functions (an acquirer 111, an instruction receiver 112, an audio analyzer 113, a presenter 114, and a reproduction controller 115). The functions of the controller 11 may be implemented by a plurality of separate devices. One, some, or all of the functions of the controller 11 may be implemented by a dedicated electronic circuit.

The acquirer 111 acquires the audio signal S1. Specifically, the acquirer 111 sequentially reads out samples of the audio signal S1 from the storage device 12. The acquirer 111 may acquire the audio signal S1 from an external device communicable with the electronic musical instrument 10.

The instruction receiver 112 receives an instruction from the user via the operation device 14. Specifically, the instruction receiver 112 receives an instruction from the user that is indicative of a target musical instrument, and generates instruction data D indicative of the target musical instrument.

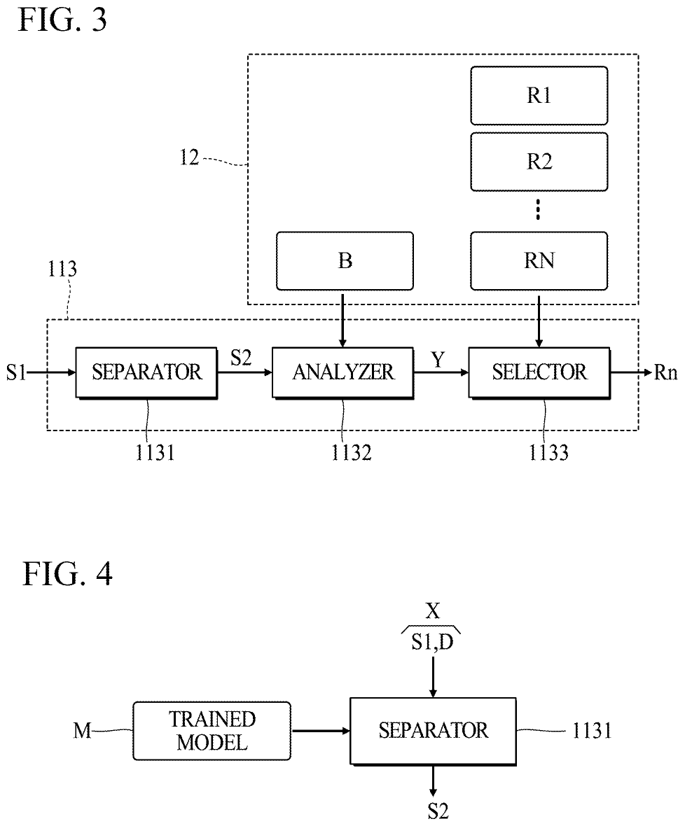

FIG. 3 is a block diagram showing a functional configuration of the audio analyzer 113. The audio analyzer 113 includes a separator 1131, an analyzer 1132, and a selector 1133.

FIG. 4 is a diagram showing the separator 1131. The separator 1131 generates an audio signal S2 by carrying out sound source separation processing on the audio signal S1. Specifically, the separator 1131 separates the audio signal S2 from among the plurality of audio components included in the audio signal S1. In other words, the separator 1131 extracts the audio signal S2 from the audio signal S1. The plurality of audio components included in the audio signal S1 correspond to different musical instruments. The audio signal S2 is representative of audio components that correspond to the target musical instrument indicated by the user. The plurality of audio components included in the audio signal S1 includes not only the audio components that correspond to the target musical instrument, but also audio components other than the audio components that correspond to the target musical instrument. The audio signal S2 may be referred to as a signal in which the audio components that correspond to the target musical instrument are emphasized relative to the audio components other than the audio components that correspond to the target musical instrument. The audio signal S2 is an example of a “second audio signal.”

The separator 1131 uses a trained model M to generate the audio signal S2. Specifically, the separator 1131 causes the trained model M to output the audio signal S2 by inputting input data X into the trained model M. The input data X is a combination of the audio signal S1 and the instruction data D. The trained model M is a model that is trained by machine learning to learn a relationship between (i) a combination of an audio signal S1 and instruction data D, and (ii) an audio signal S2.

The trained model M may be constituted of a deep neural network (DNN). The trained model M may be a freely selected neural network, such as a recurrent neural network (RNN) or a convolutional neural network (CNN). The trained model M may be constituted of a combination of different deep neural networks. The trained model M may include additional elements, such as long short-term memory (LSTM).

The trained model M is implemented by a combination of a program and multiple variables. The program causes the controller 11 to execute an operation to generate the audio signal S2 from the input data X, which is a combination of the audio signal S1 and the instruction data D. The multiple variables, such as weights and biases, are used for the operation. The program and the multiple variables for implementing the trained model M are stored in the storage device 12. Numerical values of the multiple variables for defining the trained model M are set in advance by machine learning.

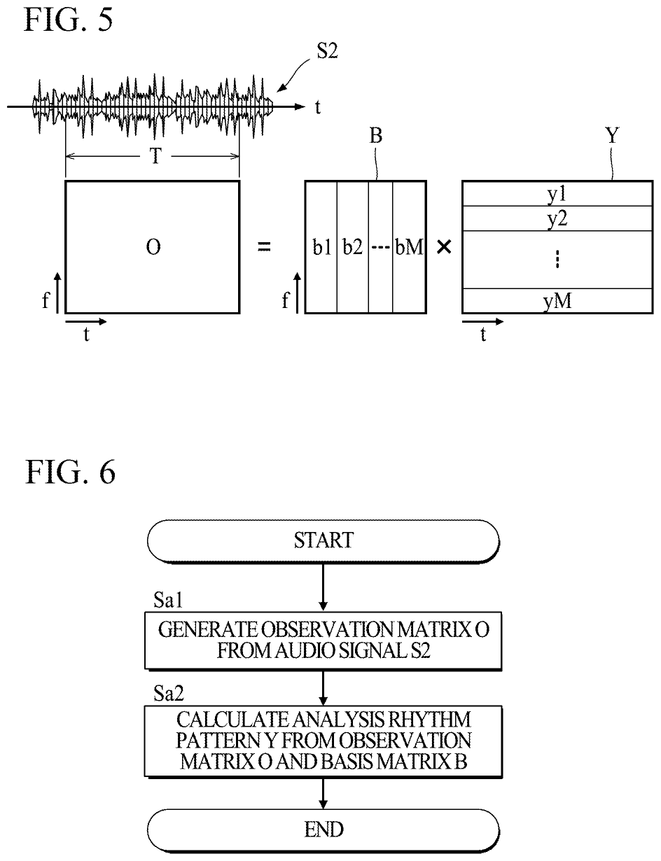

The analyzer 1132 shown in FIG. 3 analyzes the audio signal S2 to generate an analysis rhythm pattern Y. FIG. 5 is a diagram showing the analysis rhythm pattern Y. Symbols f in FIG. 5 stand for frequency, and symbols t stand for time. The analyzer 1132 divides the audio signal S2 on a time-axis into multiple portions T of the audio signal S2. Each of the portions T of the audio signal S2 is referred to as a “unit portion T.” The analyzer 1132 generates the analysis rhythm pattern Y from each of the unit portions T. Each of the unit portions T may have a duration that corresponds to a predetermined number of measures (for example, one measure, four measures, or eight measures) in a piece of music.

The analysis rhythm pattern Y is constituted of M rows of coefficients that correspond to M different timbres. The M different timbres correspond to M different musical instruments. Thus, the M rows of coefficients correspond to the M different musical instruments. The M rows of coefficients are rows of coefficients y1 to yM. Each of the rows of coefficients y1 to yM may be referred to as a row of coefficients yin (m=1 to M). The row of coefficients yin corresponds to an m-th timbre among the M different timbres. In other words, the row of coefficients yin corresponds to an m-th musical instrument among the M different musical instruments. The row of coefficients yin is representative of a temporal change in a signal intensity (for example, amplitude or power) of audio components of the m-th timbre in the audio that is represented by the audio signal S2. For example, in a case in which the audio that is represented by the audio signal S2 does not include the m-th timbre, each element of the row of coefficients yin may be represented by zero. The row of coefficients yin is a row of non-negative numerical values. Here, a timbre varies with a type of musical instrument. In addition, a timbre varies with a pitch of audio. Thus, the row of coefficients yin may be representative of a temporal change in an intensity of audio components that correspond to a combination of a musical instrument and a pitch.

The analyzer 1132 generates the analysis rhythm pattern Y from the audio signal S2 by non-negative matrix factorization (NMF) using a known basis matrix B. The basis matrix B is a non-negative matrix that includes M frequency characteristics. The M frequency characteristics are constituted of frequency characteristics b1 to bM. The frequency characteristics b1 to bM correspond to the M different timbres produced by the M different musical instruments. The frequency characteristic bin corresponds to audio components of the m-th musical instrument. The frequency characteristic bin is a column of an intensity (basis vector) of the audio components of the m-th musical instrument on a frequency-axis. The frequency characteristic bin may be an amplitude spectrum or may be a power spectrum. The basis matrix B is generated in advance by machine learning. The basis matrix B is stored in the storage device 12.

As will be understood from the above description, the analysis rhythm pattern Y is a non-negative coefficient matrix (activation matrix) that corresponds to the basis matrix B. In other words, the row of coefficients yin of the analysis rhythm pattern Y is representative of a temporal change in weight (activity) for the frequency characteristic bin in the basis matrix B. The row of coefficients yin may be referred to as a rhythm pattern for the m-th timbre represented by the audio signal S2.

FIG. 6 is a flowchart showing a processing procedure of the analyzer 1132 to generate the analysis rhythm pattern Y. The processing shown in FIG. 6 is executed for each of the unit portions T of the audio signal S2.

The analyzer 1132 generates an observation matrix O for the unit portion T of the audio signal S2 (Sa1). The observation matrix O is a non-negative matrix representative of a time series of frequency characteristics of the audio signal S2, as shown in FIG. 5. The observation matrix O may be generated as either a time series (spectrogram) of amplitude spectrum of the unit portion T or a time series (spectrogram) of power spectrum of the unit portion T.

The analyzer 1132 calculates the analysis rhythm pattern Y from the observation matrix O by non-negative matrix factorization using the basis matrix B stored in the storage device 12 (Sa2). Specifically, the analyzer 1132 calculates the analysis rhythm pattern Y such that the product of the basis matrix B and the analysis rhythm pattern Y are close (ideally, identical) to the observation matrix O.

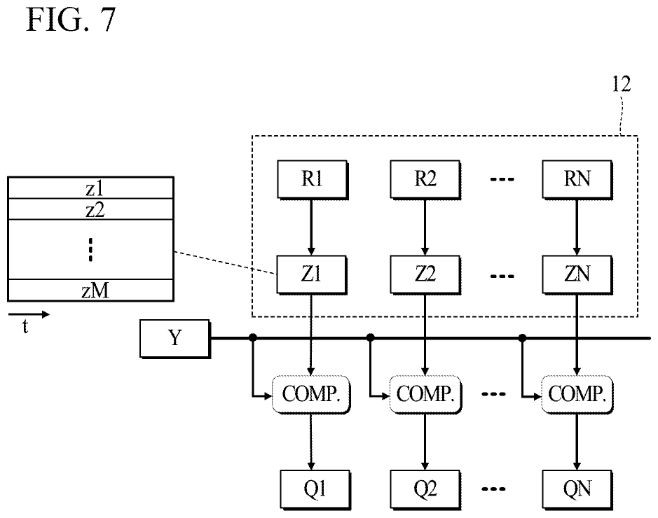

FIG. 7 is a diagram showing an operation of the selector 1133 shown in FIG. 3. The storage device 12 stores N reference signals and N reference rhythm patterns. The N reference signals are constituted of reference signals R1 to RN that are respectively representative of different pieces of audio. Each of the reference signals R1 to RN may be referred to as a reference signal Rn (n=1 to N). The N reference rhythm patterns are constituted of reference rhythm patterns Z1 to ZN that respectively correspond to the reference signals R1 to RN. Each of the reference rhythm patterns Z1 to ZN may be referred to as a reference rhythm pattern Zn. The reference rhythm pattern Zn is constituted of M rows of coefficients z1 to zM. Each of the rows of coefficients z1 to zM may be referred to as a row of coefficients zm. The row of coefficients zm corresponds to the m-th timbre among the M different timbres. The row of coefficients zm is representative of a temporal change in a signal intensity of the audio components of the m-th timbre in sound produced by a particular musical instrument, such as an n-th musical instrument. For example, in a case in which a sound produced by the particular musical instrument does not include the m-th timbre, each element of the row of coefficients zm may be represented by zero. Accordingly, the reference rhythm pattern Zn is determined based on sound produced by a particular musical instrument, such as an n-th musical instrument.

The reference signals R1 to RN are in one-to-one correspondence with different portions of a piece of music. Each of the reference signals R1 to RN is representative of audio of the corresponding portion of a piece of music. Each of the reference signals R1 to RN may be referred to as a reference signal Rn. The reference signal Rn may be representative of a portion (i.e., loop) of a piece of music that is appropriate for repeat playing. The reference signal Rn may be representative of audio of the portion of a piece of music played by the n-th musical instrument. In this embodiment, the reference rhythm patterns Z1 to ZN are respectively generated from the reference signals R1 to RN.

The selector 1133 compares each of the reference rhythm patterns Z1 to ZN with the analysis rhythm pattern Y. Specifically, the selector 1133 compares the reference rhythm pattern Zn with the analysis rhythm pattern Y to calculate a degree of similarity Qn between the reference rhythm pattern Zn and the analysis rhythm pattern Y. As an example of the degree of similarity Qn, a correlation coefficient may be used. The correlation coefficient is an indicator of a correlation between the reference rhythm pattern Zn and the analysis rhythm pattern Y. Accordingly, the greater a similarity between the reference rhythm pattern Zn and the analysis rhythm pattern Y, the greater a numerical value of the degree of similarity Qn. In other words, the degree of similarity Qn is an indicator of the degree of similarity between the reference rhythm pattern Zn and the analysis rhythm pattern Y.

The selector 1133 selects, based on the calculated degree of similarity Qn for each of the reference rhythm patterns Z1 to ZN, one or more reference signals Rn from among the reference signals R1 to RN. The selector 1133 provides the selected one or more reference signals Rn to the presenter 114 and the reproduction controller 115. The selector 1133 may select a plurality of reference signals Rn each of which has a degree of similarity Qn greater than a predetermined threshold. Alternatively, the selector 1133 may select a predetermined number of reference signals Rn in descending order of degree of similarity Qn.

As will be understood from the above description, based on the target musical instrument (target timbre) and the audio signal S1, the audio analyzer 113 (selector 1133) selects, from among the reference signals R1 to N, a plurality of reference signals Rn for each of which the reference rhythm pattern Zn is similar to the analysis rhythm pattern Y. The selector 1133 may select a predetermined number of reference signals Rn for each of the unit portions T of the audio signal S2. Alternatively, the selector 1133 may select a predetermined number of reference signals Rn in descending order of average of degree of similarity for all the unit portions T.

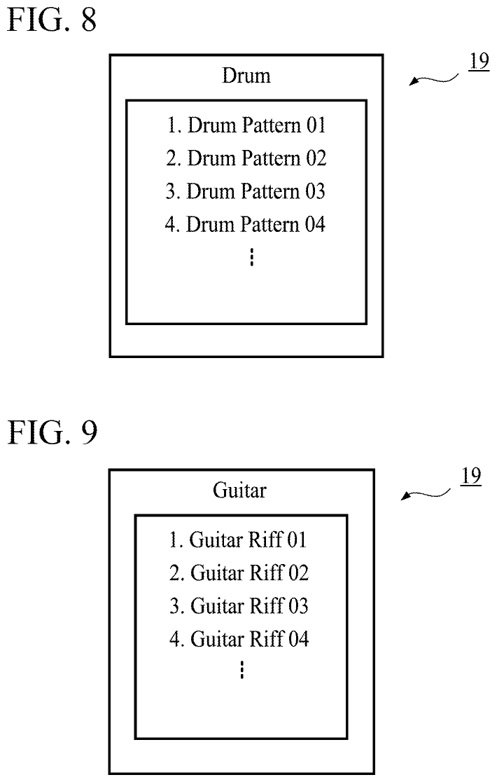

The presenter 114 shown in FIG. 2 causes the display 19 to display a result of the analysis by the audio analyzer 113. The presenter 114 may display the plurality of reference signals Rn selected by the selector 1133 on the display 19. The presenter 114 may display a reference signal Rn selected by the selector 1133 on the display 19. The presenter 114 according to the first embodiment causes the display 19 to display an analysis image as shown in FIG. 8 or in FIG. 9. The analysis image is an image representative of the reference signals Rn in a ranking format.

The analysis image in FIG. 8 is an image representative of reference signals Rn corresponding to reference rhythm patterns Zn that are similar to an analysis rhythm pattern Y for a target musical instrument “Drums.” The analysis image in FIG. 9 is an image representative of reference signals Rn corresponding to reference rhythm patterns Zn that are similar to an analysis rhythm pattern Y for a target musical instrument “Guitar.”

By referring to the analysis image in FIG. 8 or in FIG. 9, the user can visually identify reference signals Rn corresponding to reference rhythm patterns Zn that are similar to the analysis rhythm pattern Y for the target musical instrument. For example, by referring to the analysis image shown in FIG. 8, the user can readily identify a reference signal Rn corresponding to the reference rhythm pattern Zn that is most similar to the analysis rhythm pattern Y for the target musical instrument “Drums.” The character strings shown in FIG. 8 and in FIG. 9, “Drum Pattern 01” and “Guitar Riff 01,” are labels for reference signals Rn, and each label has a number such as “1” at its left that designates a rank corresponding to a degree of similarity Qn. Thus, in FIG. 8, a reference signal Rn labelled “Drum Pattern 01” has a greatest degree of similarity Qn. In FIG. 9, a reference signal Rn labelled “Guitar Riff 01” has a greatest degree of similarity Qn.

The reproduction controller 115 shown in FIG. 2 controls emission of a sound by the playback system 18. Specifically, the reproduction controller 115 instructs the playback system 18 (specifically, the audio source 16) to emit a sound in response to an operation made by the user to the playing input device 15. The reproduction controller 115 causes the playback system 18 to emit a sound represented by a reference signal Rn selected by the user from the analysis image, from among the plurality of reference signals Rn selected by the selector 1133. The reproduction controller 115 may cause the playback system 18 to emit one or more sounds represented by one or more reference signals Rn selected by the user from the analysis image, from among the plurality of reference signals Rn selected by the selector 1133.

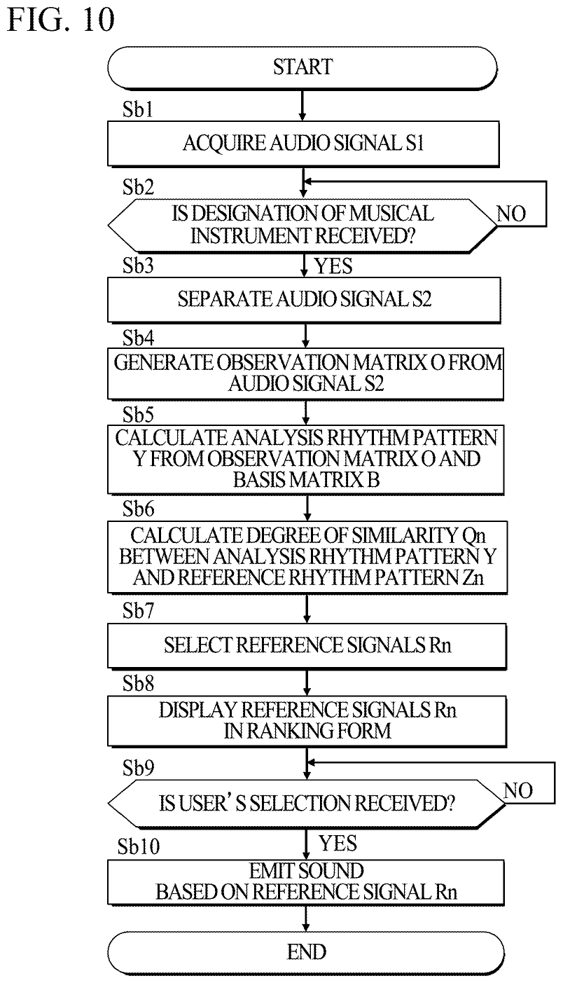

FIG. 10 is a flowchart showing a processing procedure (hereinafter referred to as “audio analysis processing”) executed by the controller 11. For example, the audio analysis processing starts in response to receipt by the electronic musical instrument 10 of an instruction made by the user.

When the audio analysis processing starts, the acquirer 111 acquires the audio signal S1 (Sb1). The instruction receiver 112 awaits receipt of designation of the target musical instrument by the user (Sb2: NO). Upon receipt at the instruction receiver 112 of the designation of the target musical instrument (Sb2: YES), the separator 1131 separates the audio signal S2 from the audio signal S1 (Sb3).

The analyzer 1132 generates the observation matrix O (see FIG. 5) for each of the unit portions T obtained by dividing the audio signal S2 on the time-axis (Sb4). The analyzer 1132 calculates the analysis rhythm pattern Y from each observation matrix O by non-negative matrix factorization using the basis matrix B stored in the storage device 12 (Sb5).

The selector 1133 calculates the degree of similarity Qn between the analysis rhythm pattern Y and the reference rhythm pattern Zn for each of the reference signals R1 to RN (Sb6). The selector 1133 selects, from among the reference signals R1 to RN, a plurality of reference signals Rn for each of which the reference rhythm pattern Zn is similar to the analysis rhythm pattern Y (Sb7).

The presenter 114 causes the display 19 to display labels for identifying the plurality of reference signals Rn selected by the selector 1133 in descending order of degree of similarity Qn (Sb8). The reproduction controller 115 waits for the user to select one of the plurality of reference signals Rn (Sb9: NO). Upon selection by the user of the one of the plurality of reference signals Rn on the display 19 (Sb9: YES), the reproduction controller 115 provides the selected reference signal Rn to the playback system 18 to cause the playback system 18 to emit a sound represented by the selected reference signal Rn (Sb10).

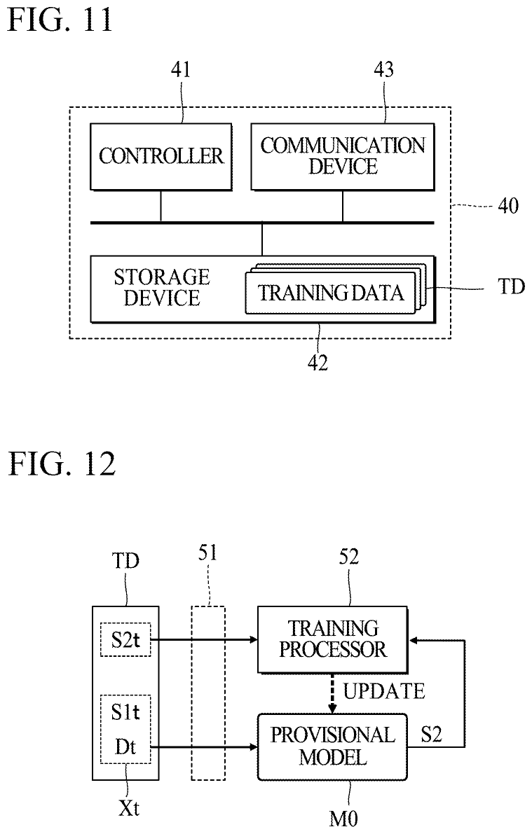

The information processing system 40 in FIG. 1 generates the trained model M that is used by the separator 1131 to generate the audio signal S2. FIG. 11 is a block diagram showing a configuration of the information processing system 40. The information processing system 40 includes a controller 41, a storage device 42, and a communication device 43. The information processing system 40 may be constituted of a single integrated device, or may be constituted of a plurality of separate devices.

The controller 41 is constituted of one or more processors configured to control components of the information processing system 40. The controller 41 is may be constituted of one or more types of processors such as a CPU, an SPU, a DSP, an FPGA, or an ASIC. The communication device 43 communicates with the electronic musical instrument 10 via the communication network 90.

The storage device 42 includes one or more memories configured to store a program executed by the controller 41 and a variety of types of data used by the controller 41. The storage device 42 may be constituted of a known recording medium such as a magnetic recording medium or a semiconductor recording medium, or alternatively the storage device 42 may be constituted of a combination of different types of recording media. The storage device 42 may be a portable recording medium that is detachable from the information processing system 40. The storage device 42 may be a recording medium (for example, a cloud storage server) that is accessible by the controller 41 via the communication network 90.

FIG. 12 is a block diagram showing a functional configuration of the information processing system 40. The controller 41 executes the program stored in the storage device 42 to function as a plurality of elements (a training data acquirer 51 and a training processor 52) configured to establish the trained model M by machine learning.

The training processor 52 establishes the trained model M by supervised machine learning using multiple pieces of training data TD. The training data acquirer 51 acquires the multiple pieces of training data TD. The training data acquirer 51 may acquire the multiple pieces of training data TD from the storage device 42 that stores the multiple pieces of training data TD.

Each of the multiple pieces of training data TD is constituted of a combination of training input data Xt and training audio signal S2t, as shown in FIG. 12. The training input data Xt is data that is constituted of a combination of a training audio signal S1t and training instruction data Dt. The training audio signal S1t is a known signal that includes a plurality of audio components corresponding to different musical instruments (for example, the M different musical instruments). The training audio signal S1t is an example of a “first training audio signal.”

The training instruction data Dt is data indicative of one type of musical instrument among different types of musical instruments. The training instruction data Dt is an example of “training instruction data.” The training audio signal S2t is a known signal representative of audio components, which correspond to the musical instrument indicated by the training instruction data Dt, among the plurality of audio components included in the training audio signal S1t. The training audio signal S2t is an example of a “second training audio signal.”

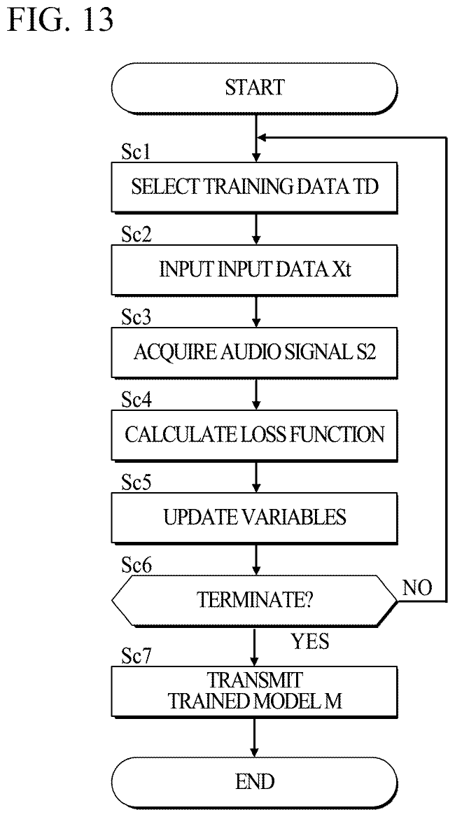

FIG. 13 is a flow chart showing a processing procedure (hereinafter, referred to as “learning processing”) Sc by which the controller 41 establishes the trained model M by machine learning. The learning processing Sc may be referred to as a method of generating the trained model M.

When the learning processing Sc starts, the training data acquirer 51 acquires one (hereinafter referred to as selected training data TD) of the multiple pieces of training data TD stored in the storage device 42 (Sc1). As shown in FIG. 12, the training data acquirer 51 provides the training processor 52 with the training audio signal S2t of the selected training data TD. The training data acquirer 51 inputs the input data Xt of the selected training data TD into an initial or provisional model (hereinafter referred to as a “provisional model”) MO (Sc2). The training processor 52 acquires an audio signal S2 output from the provisional model MO in response to input of the input data Xt (Sc3).

The training processor 52 calculates a loss function indicative of a difference between the audio signal S2, which is generated by the provisional model MO, and the training audio signal S2t of the selected training data TD (Sc4). The training processor 52 updates multiple variables for the provisional model MO such that the loss function is reduced (ideally, minimized) (Sc5). To update the multiple variables in accordance with the loss function, a backpropagation method is used, for example.

The training processor 52 determines whether a termination condition is satisfied (Sc6). The termination condition may be a condition in which the loss function is less than a predetermined threshold. Alternatively, the termination condition may be a condition in which an amount of a change in the loss function is less than a predetermined threshold. When the termination condition is not satisfied (Sc6: NO), the training data acquirer 51 reads out new selected training data TD that has not yet been selected (Sc1). Thus the training processor 52 repeats processing (Sc1 to Sc5) to update the multiple variables for the provisional model MO until the termination condition is satisfied. When the termination condition is satisfied (Sc6: YES), the training processor 52 terminates the processing (Sc1 to Sc5) to update the multiple variables that define the provisional model MO. The provisional model MO, which is at a point in time at which the termination condition is satisfied, is defined as trained model M. In other words, the multiple variables of the trained model M are defined as values that are at a point in time at which the learning processing Sc is terminated.

As will be understood from the above description, the trained model M outputs a statistically reasonable audio signal S2 for unknown input data X based on a potential relationship between the training input data Xt of the multiple pieces of selected training data TD and the training audio signals S2t of the multiple pieces of selected training data TD. In other words, the trained model M is a model that is trained by machine learning to learn a relationship between the training input data Xt and the training audio signal S2t.

The information processing system 40 transmits the trained model M established by the processing described above from the communication device 43 to the electronic musical instrument 10 (Sc7). Specifically, the training processor 52 transmits the multiple variables for the trained model M from the communication device 43 to the electronic musical instrument 10. The controller 11 of the electronic musical instrument 10 stores the trained model M received from the information processing system 40 in the storage device 12. Specifically, the multiple variables that define the trained model M may be stored in the storage device 12.

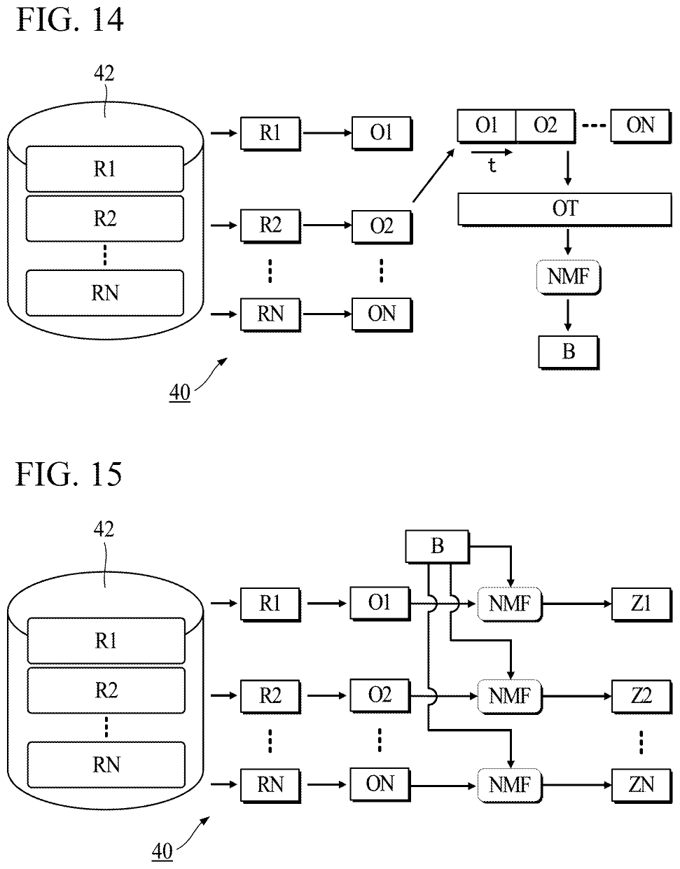

The information processing system 40 shown in FIG. 1 generates not only the basis matrix B used by the analyzer 1132 and the selector 1133, but also the reference rhythm patterns Zn. FIG. 14 is a diagram showing generation of the basis matrix B by the information processing system 40. FIG. 15 is a diagram showing generation of the reference rhythm patterns Zn by the information processing system 40. The basis matrix B and the reference rhythm patterns Zn are generated in the following manner, for example.

As shown in FIG. 14, the controller 41 reads out the reference signals R1 to RN stored in the storage device 42. The controller 41 generates an observation matrix On from each of the reference signals Rn. The observation matrix On as well as the observation matrix O is a non-negative matrix. The observation matrix On is representative of a time series (spectrogram) of frequency characteristics of the reference signal Rn.

The controller 41 connects the observation matrixes 01 to ON with each other on the time-axis to generate an observation matrix OT. The controller 41 generates the basis matrix B from the observation matrix OT by non-negative matrix factorization on the observation matrix OT. As will be understood from the above description, the basis matrix B includes the frequency characteristics b1 to bin that correspond to all types of timbres included in the reference signals R1 to RN. The frequency characteristics b1 to bin have a one-to-one correspondence with all the types of timbres included in the reference signals R1 to RN.

As shown in FIG. 15, the controller 41 calculates the reference rhythm pattern Zn from each of the observation matrixes On by non-negative matrix factorization using the generated basis matrix B. Specifically, the controller 41 calculates the reference rhythm pattern Zn such that the product of the basis matrix B and the reference rhythm pattern Zn is close (ideally, identical) to the observation matrix On. The information processing system 40 transmits the basis matrix B and reference-rhythm patterns Z1 to ZN from the communication device 43 to the electronic musical instrument 10. The controller 11 of the electronic musical instrument 10 stores the basis matrix B and the reference rhythm patterns Z1 to ZN received from the information processing system 40 in the storage device 12.

As described above, in the first embodiment, from among the plurality of reference signals Rn, reference signals Rn are selected for each of which the reference rhythm pattern Zn is similar to the analysis rhythm pattern Y for the musical instrument (target musical instrument) indicated by the user. As a result, an amount of time required by the user in finding a rhythm pattern appropriate for a musical instrument indicated by the user is reduced, and efficacy in creating piece of music or in practicing a piece of music is increased.

In the first embodiment, the reference signals Rn are appropriately selected based on the degree of similarity Qn between the reference rhythm pattern Zn for each of the reference signals R1 to RN and the analysis rhythm pattern Y for the musical instrument indicated by the user.

In the first embodiment, the user can identify an order of the plurality of reference signals Rn, which is based on the similarity between the reference rhythm pattern Zn for each of the plurality of reference signals Rn and the analysis rhythm pattern Y for the target musical instrument. Thus, the user can create a piece of music or practice playing a piece of music in the order of the plurality of reference signals Rn, for example.

In the first embodiment, by referring to the analysis image in FIG. 8 or in FIG. 9, the user can visually identify the reference signals Rn, which correspond to the reference rhythm patterns Zn similar to the analysis rhythm pattern Y for the target musical instrument, from among the plurality of reference signals Rn.

### B: Second Embodiment

A second embodiment will now be described. In the descriptions of the following embodiments, elements having the same functions and the same configurations as in the first embodiment are denoted by the same reference numerals as used for like elements in the description of the first embodiment, and detailed description thereof is omitted, as appropriate.

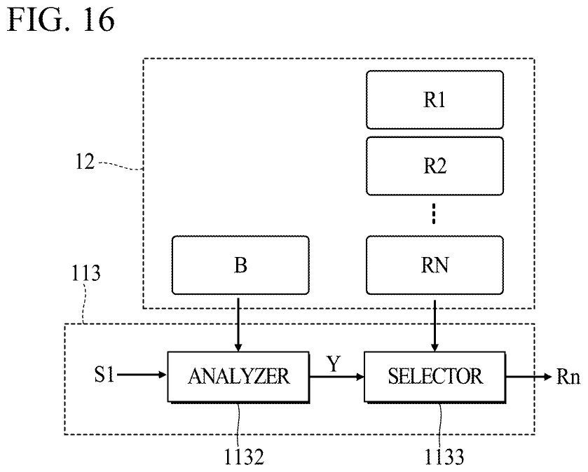

FIG. 16 is a block diagram showing a configuration of the audio analyzer 113 according to the second embodiment. The audio analyzer 113 according to the second embodiment has a configuration in which the separator 1131 is removed from the audio analyzer 113 according to the first embodiment (the separator 1131, the analyzer 1132, and the selector 1133). Specifically, in the first embodiment, the separator 1131 different from the analyzer 1132 generates the audio signal S2 in which the audio components of the target musical instrument are emphasized. In the second embodiment, the analyzer 1132 emphasizes the audio components of the target musical instrument while generating the analysis rhythm pattern Y.

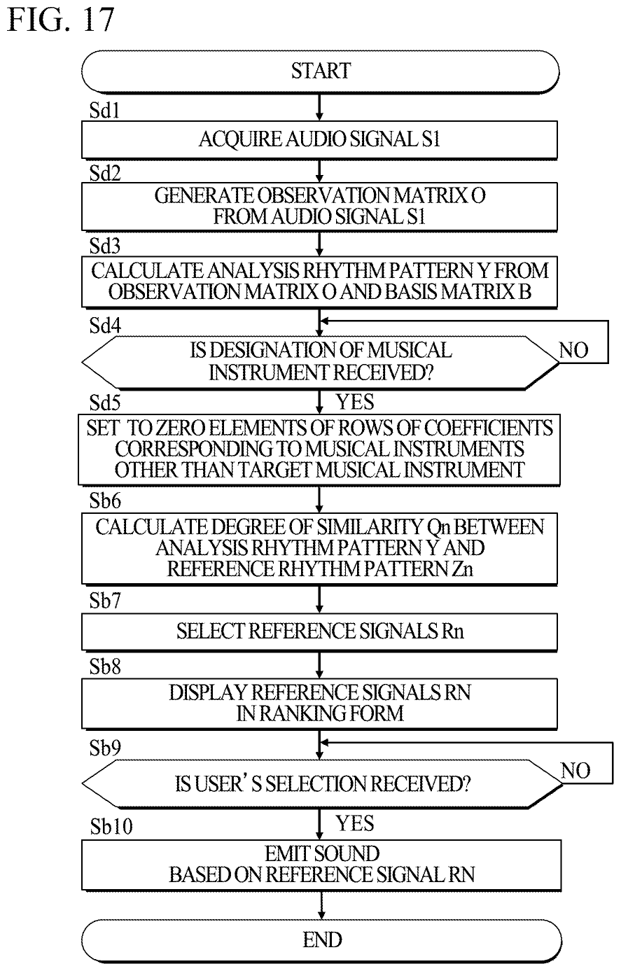

FIG. 17 is a flowchart showing a processing procedure (audio analysis processing) executed by the controller 11 according to the second embodiment.

When the audio analysis processing starts, the acquirer 111 acquires the audio signal S1 (Sd1). The analyzer 1132 generates the observation matrix O for each of the unit portions T obtained by dividing the audio signal S1 on the time-axis (Sd2). The observation matrix O according to the first embodiment is a non-negative matrix that corresponds to the audio signal S2 obtained by carrying out sound source separation processing. The observation matrix O according to the second embodiment is a non-negative matrix representative of a time series of frequency characteristics of the audio signal S1. The observation matrix O according to the second embodiment may be either a time series (spectrogram) of amplitude spectrum of the unit portion T or a time series (spectrogram) of power spectrum of the unit portion T.

The analyzer 1132 then calculates the analysis rhythm pattern Y from the observation matrix O by non-negative matrix factorization using the basis matrix B (Sd3). The basis matrix B is labeled with names of musical instruments. Specifically, the musical instrument name is labeled for each of the frequency characteristics b1 to bM that constitute the basis matrix B. Thus, a musical instrument is known that corresponds to the m-th frequency characteristic among the frequency characteristics b1 to bM.

The instruction receiver 112 waits for designation of the target musical instrument by the user (Sd4: NO). In response to the instruction receiver 112 receiving the designation of the target musical instrument (Sd4: YES), the analyzer 1132 sets elements of one or more rows of coefficients yin to be zero (Sd5). The one or more rows of coefficients yin are included in the rows of coefficients y1 to yM that constitute the analysis rhythm pattern Y, and the one or more rows of coefficients yin respectively correspond to musical instruments other than the target musical instrument. As a result, the analysis rhythm pattern Y is changed to a non-negative matrix in which the elements of the one or more rows of coefficients yin, which correspond to musical instruments other than the target musical instrument, are represented by zero.

When completing the above processing, the controller 11 executes processing from step Sb6 to step Sb10 as in the first embodiment. Accordingly, the second embodiment provides the same effects as those provided by the first embodiment.

### C: Third Embodiment

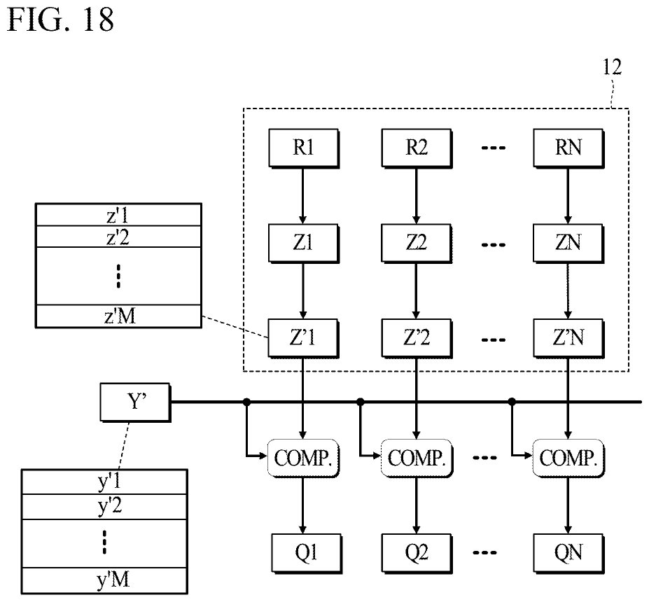

FIG. 18 is a diagram showing the selector 1133 according to a third embodiment. The selector 1133 compresses the analysis rhythm pattern Y on the time-axis into a compressed analysis rhythm pattern Y′. Specifically, the selector 1133 generates the compressed analysis rhythm pattern Y′ by compressing a plurality of elements in each of the plurality of rows of coefficients y1 to yM that constitute the analysis rhythm pattern Y as an average or a sum of the plurality of elements. Thus, the compressed analysis rhythm pattern Y′ is constituted of coefficients y′1 to y′M corresponding to the M different timbres. Each of the coefficients y′1 to y′M may be referred to as a coefficient y′m. The coefficient y′m may be the average or the sum of the plurality of elements of the row of coefficients yin. The coefficient y′m corresponding to the m-th timbre among the M types of timbres is a non-negative numerical value representative of the intensity of the audio components of the m-th timbre. The plurality of rows of coefficients y1 to yM is an example of a second plurality of rows of coefficients.

Similarly, the selector 1133 generates a compressed reference rhythm pattern Z′n from each of the reference rhythm patterns Z1 to ZN. The compressed reference rhythm patterns Z′1 to Z′N are stored in the storage device 12. The selector 1133 compresses the reference rhythm pattern Zn on the time-axis into the compressed reference rhythm pattern Z′n. Specifically, the selector 1133 generates the compressed reference rhythm pattern Z′n by compressing a plurality of elements in each of the plurality of rows of coefficients z1 to zM that constitute the reference rhythm pattern Zn as an average or a sum of the plurality of elements. Thus, the compressed reference rhythm pattern Z′n is constituted of coefficients z′1 to z′M corresponding to the M different timbres. Furthermore, since the reference rhythm pattern Zn is determined based on sound produced by a particular musical instrument, such as an n-th musical instrument, the compressed reference rhythm pattern Z′n is determined based on sound produced by the particular musical instrument, such as an n-th musical instrument. Each of the coefficients z′1 to z′M may be referred to as a coefficient z′m. The coefficient z′m may be the average or the sum of the plurality of elements of the row of coefficients zm. The coefficient z′m corresponding to the m-th timbre among the M types of timbres is a non-negative numerical value representative of the intensity of the audio components of the m-th timbre. The plurality of rows of coefficients z1 to zM is an example of a first plurality of rows of coefficients.

The selector 1133 compares each of the compressed reference rhythm patterns Z′1 to Z′N with the compressed analysis rhythm pattern Y′ to calculate the degree of similarity Qn. As will be understood from the above description, the selector 1133 according to the foregoing embodiments calculates the degree of similarity Qn by comparing the reference rhythm pattern Zn with the analysis rhythm pattern Y. The selector 1133 according to the third embodiment calculates the degree of similarity Qn by comparing the compressed reference rhythm pattern Z′n, which is obtained by compressing the reference rhythm pattern Zn on the time-axis, with the compressed analysis rhythm pattern Y′, which is obtained by compressing the analysis rhythm pattern Y on the time-axis.

The third embodiment provides the same effects as those provided by the first embodiment. The configuration of the first embodiment or of the second embodiment may be applied to the third embodiment.

### D: Fourth embodiment

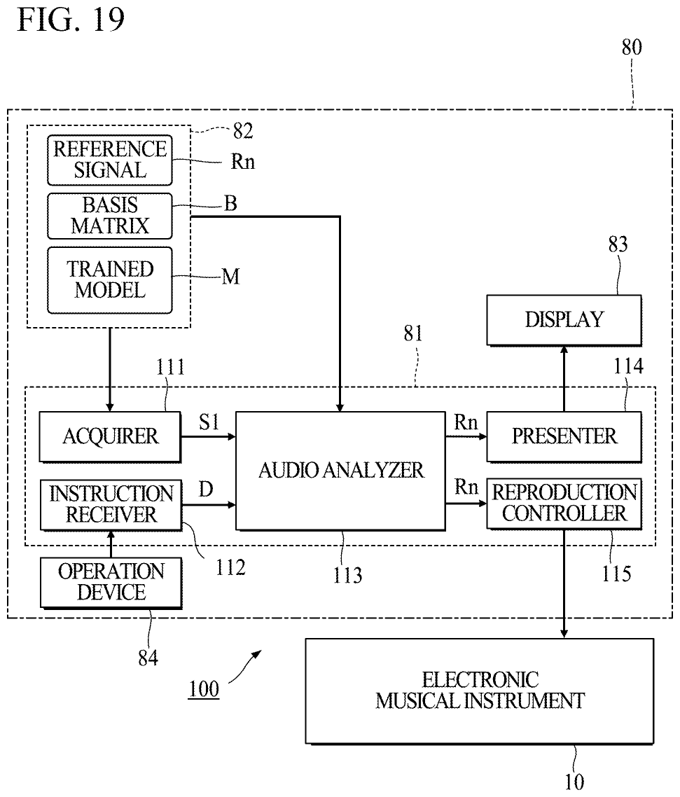

FIG. 19 is a block diagram showing a configuration of a playing system 100 according to a fourth embodiment. The playing system 100 includes the electronic musical instrument 10 and an information device 80. The information device 80 is a device such as a smartphone or a tablet terminal. The information device 80 may be connected to the electronic musical instrument 10 either by wire or wirelessly.

The information device 80 is implemented by a computer system that includes a controller 81, a storage device 82, a display 83, and an operation device 84. The controller 81 is constituted of one or more processors configured to control components of the information device 80. The controller 81 may be constituted of one or more types of processors such as a CPU, an SPU, a DSP, an FPGA, or an ASIC.

The storage device 82 includes one or more memories configured to store a program executed by the controller 81 and a variety of types of data for use by the controller 81. The storage device 82 may be constituted of a known recording medium such as a magnetic recording medium or a semiconductor recording medium. Alternatively, the storage device 82 may be constituted of a combination of different types of recording media. The storage device 82 may be a portable recording medium that is detachable from the information device 80, or may be a recording medium (for example, a cloud storage server) that is accessible by the controller 81 via the communication network 90.

The display 83 displays images under control of the controller 81. The operation device 84 is an input device configured to receive instructions from the user. The operation device 84 receives the instruction indicative of the target musical instrument from the user.

The controller 81 executes the program stored in the storage device 82 to implement the same functions (the acquirer 111, the instruction receiver 112, the audio analyzer 113, the presenter 114, and the reproduction controller 115) as the controller 11 of the electronic musical instrument 10 according to the first embodiment. The reference signals Rn, the basis matrix B, and the trained model M used by the audio analyzer 113 are stored in the storage device 82. The storage device 82 further stores the audio signal S1. According to the fourth embodiment, the functions (the acquirer 111, the instruction receiver 112, the audio analyzer 113, the presenter 114, and the reproduction controller 115) described in the first embodiment may be omitted from the electronic musical instrument 10. One, some, or all of the functions of the electronic musical instrument 10 may be implemented by the information device 80 instead of the electronic musical instrument 10. One, some, or all of the functions of the information device 80 may be implemented by the electronic musical instrument 10 instead of the information device 80. For example, one or more of the functions of the acquirer 111, the instruction receiver 112, the audio analyzer 113, the presenter 114, and the reproduction controller 115 may be implemented by the information device 80, and the others of the functions may be implemented by the electronic musical instrument 10. In other words, the playing system 100 implements a plurality of functions described above.

The acquirer 111 acquires the audio signal S1 stored in the storage device 82. The instruction receiver 112 receives instructions provided by the user to the operation device 84. As in the first embodiment, the audio analyzer 113 selects the plurality of reference signals Rn based on the audio signal S1 and the instruction data D. The presenter 114 causes the display 83 to display the plurality of reference signals Rn selected by the audio analyzer 113. The reproduction controller 115 provides the electronic musical instrument 10 with one reference signal Rn, which is selected by the user from among the displayed plurality of reference signals Rn, to cause the playback system 18 to emit a sound. The presenter 114 and the reproduction controller 115 may be implemented by the electronic musical instrument 10. The presenter 114 may cause the display 19 to display the analysis image as in the first embodiment.

As will be understood from the above description, the fourth embodiment provides the same effects as those of the first embodiment. The configuration of the second embodiment or of the third embodiment may be applied to the fourth embodiment.

In the fourth embodiment, the trained model M established by the information processing system 40 is transferred to the information device 80, and the trained model M is stored in the storage device 82. In the configuration described above, an authentication processor configured to authenticate a user (a user registered in advance) of the information device 80 may be included in the information processing system 40. When the user is authenticated by the authentication processor, the trained model M is automatically transferred to the information device 80 (i.e., without requiring instructions from the user).

### E: Fifth Embodiment

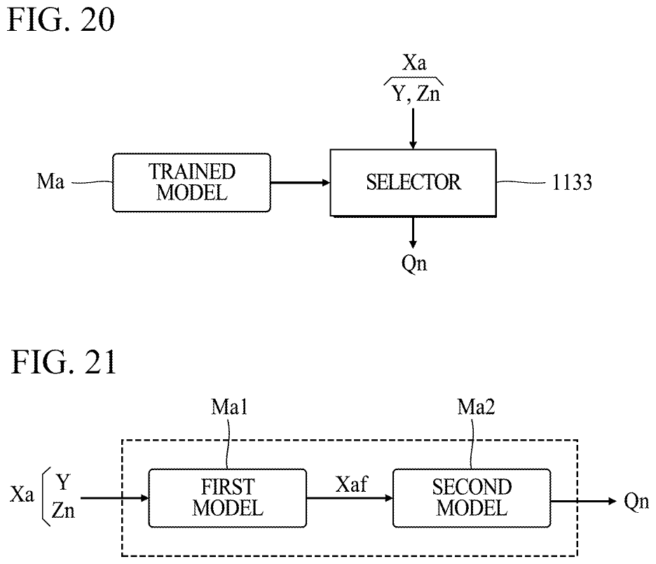

FIG. 20 is a diagram showing the selector 1133 according to a fifth embodiment. The selector 1133 according to the fifth embodiment receives input data Xa that is a combination of the analysis rhythm pattern Y and the reference rhythm pattern Zn. The selector 1133 outputs the degree of similarity Qn corresponding to the input data Xa.

The selector 1133 according to the fifth embodiment uses a trained model Ma to generate the degree of similarity Qn. The selector 1133 causes the trained model Ma to output the degree of similarity Qn by inputting the input data Xa into the trained model Ma. The trained model Ma is a model that is trained by machine learning to learn a relationship between (i) a combination of an analysis rhythm pattern Y and a reference rhythm pattern Zn, and (ii) a degree of similarity Qn.

The trained model Ma may be a freely selected deep neural network, such as a recurrent neural network or a convolutional neural network. The trained model Ma may be constituted of a combination of a recurrent neural network and a convolutional neural network.

The trained model Ma is implemented by a combination of a program and multiple variables. The program causes the controller 11 to execute an operation to generate a degree of similarity Qn from input data Xa. The multiple variables, such as weights and biases, are used for the operation. The program and the multiple variables for implementing the trained model Ma are stored in the storage device 12. Numerical values of the multiple variables for implementing the trained model Ma are set in advance by machine learning.

FIG. 21 is a block diagram showing a configuration of the trained model Ma. The trained model Ma includes a first model Ma1 and a second model Ma2. The input data Xa is input into the first model Ma1.

The first model Ma1 generates feature data Xaf from the input data Xa. The first model Ma1 is a trained model that is trained by machine learning to learn a relationship between input data Xa and feature data Xaf. The feature data Xaf is data representative of a feature corresponding to a difference between the analysis rhythm pattern Y and the reference rhythm pattern Zn. The first model Ma1 may be constituted of a convolutional neural network.

The second model Ma2 generates the degree of similarity Qn from the feature data Xaf. The second model Ma2 is a trained model that is trained by machine learning to learn a relationship between feature data Xaf and a degree of similarity Qn. The second model Ma2 may be constituted of a recurrent neural network. The second model Ma2 may include additional elements, such as long short-term memory (LSTM) or a gated recurrent unit (GRU).

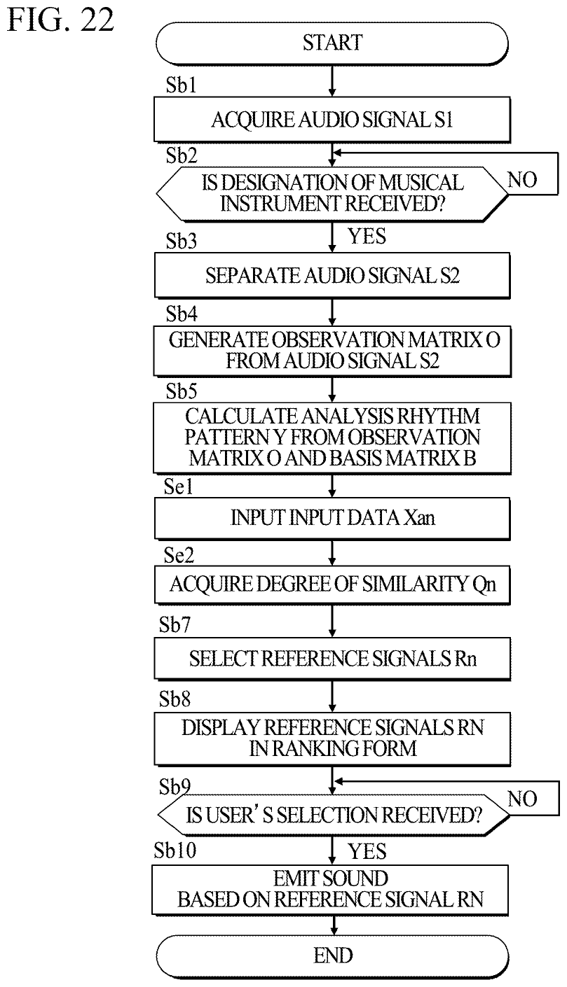

FIG. 22 is a flowchart showing a processing procedure (audio analysis processing) executed by the controller 11 according to the fifth embodiment. In the fifth embodiment, step Sb6 according to the first embodiment shown in FIG. 10, is replaced with step Se1 and step Se2. The contents of processing from step Sb1 to step Sb5 and the contents of processing from step Sb7 to step Sb10 are substantially the same as those of the first embodiment.

The selector 1133 generates input data Xa1 to XaN by combining, for each of the reference signals R1 to RN, the reference rhythm pattern Zn with the analysis rhythm pattern Y. The selector 1133 inputs input data Xan (n=1 to N) into the trained model Ma (Se1) to cause the trained model Ma to output the degree of similarity Qn that corresponds to the input data Xan (Se2). The fifth embodiment provides the same effects as those of the first embodiment.

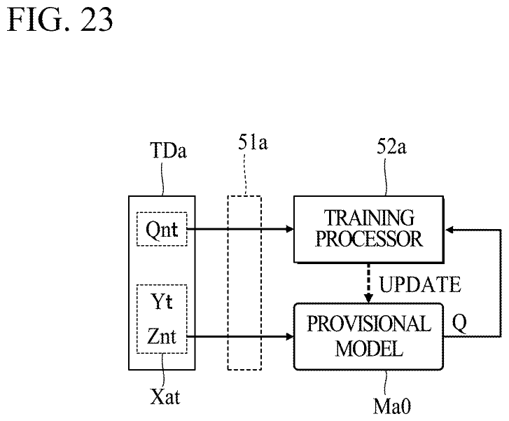

The trained model Ma is generated by the information processing system 40. FIG. 23 is a block diagram showing a functional configuration of the information processing system 40 to generate the trained model Ma. The controller 41 executes the program stored in the storage device 42 to function as a plurality of elements (a training data acquirer 51a and a training processor 52a) configured to establish the trained model Ma by machine learning.

The training processor 52a establishes the trained model Ma by supervised machine learning using multiple pieces of training data TDa. The training data acquirer 51a acquires the multiple pieces of training data TDa. The training data acquirer 51a may acquire the multiple pieces of training data TDa from the storage device 42 that stores the multiple pieces of training data TDa.

Each of the multiple pieces of training data TDa is constituted of a combination of training input data Xat and a training degree of similarity Qnt, as shown in FIG. 23. The training input data Xat is data is constituted of a combination of a training analysis rhythm pattern Yt and a training reference rhythm pattern Znt. The training analysis rhythm pattern Yt is a known coefficient matrix constituted of a plurality of rows of coefficients corresponding to different timbres (for example, M different timbres). The training reference rhythm pattern Znt is an example of a “training reference rhythm pattern.” The training analysis rhythm pattern Yt is an example of a “training analysis rhythm pattern.”

The training reference rhythm pattern Znt is a known coefficient matrix that is constituted of a plurality of rows of coefficients corresponding to different timbres. Furthermore, the training reference rhythm pattern Znt (coefficient matrix) is determined based on sound produced by a particular musical instrument. The training degree of similarity Qnt is a numerical value that is associated with the training input data Xat in advance. The training input data Xat may be associated with the training degree of similarity Qnt between the training analysis rhythm pattern Yt in the training input data Xat and the training reference rhythm pattern Znt in the training input data Xat. The training degree of similarity Qnt is an example of a “training degree of similarity.”

The training processor 52a inputs the input data Xat of a piece of training data TDa into a provisional model Ma0 for each of the multiple pieces of training data TDa. The training processor 52a updates multiple variables for the provisional model Ma0 such that a loss function is reduced (ideally, minimized) which is indicative of a difference between a degree of similarity Q output from the provisional model Ma0 for each of the multiple pieces of training data TDa and the training degree of similarity Qnt of the piece of training data TDa. As a result, the trained model Ma is trained to learn a relationship between the input data Xat and the degree of similarity Qnt. Accordingly, the trained model Ma outputs a statistically reasonable degree of similarity Qn for unknown input data Xan based on a potential relationship between the training input data Xat of the multiple pieces of training data TDa and the training degree of similarity Qnt of the multiple pieces of training data TDa.

### F: Sixth Embodiment

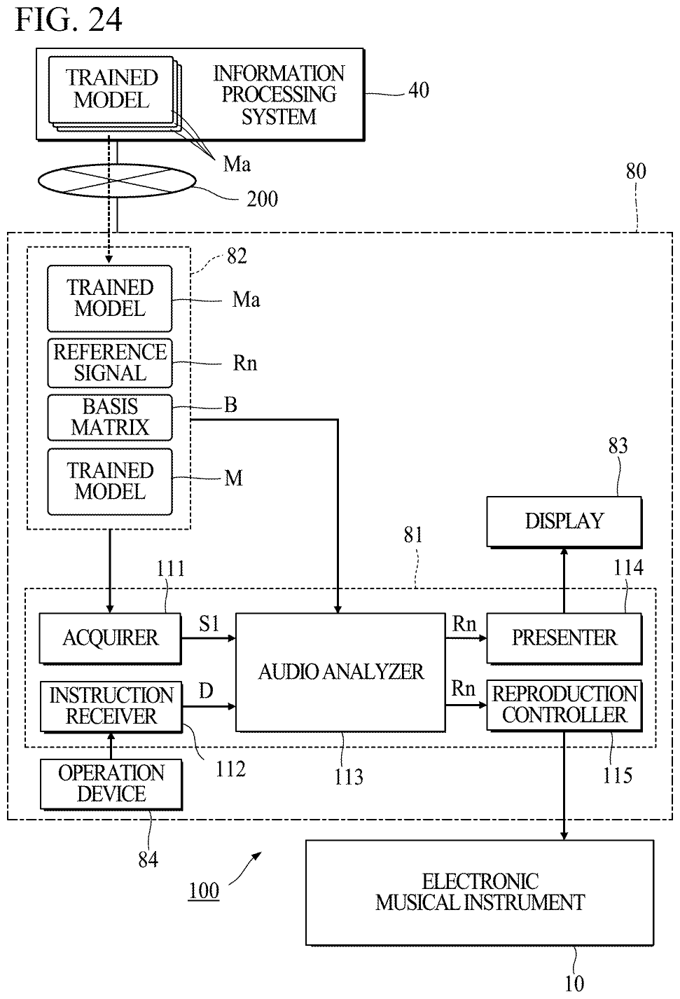

FIG. 24 is a block diagram showing a configuration of the playing system 100 according to a sixth embodiment. The playing system 100 includes the electronic musical instrument 10 and the information device 80, as in the fourth embodiment. Configurations of the electronic musical instrument 10 and the information device 80 are substantially the same as those of the fourth embodiment.

The information processing system 40 stores multiple trained models Ma that correspond to different musical genres. In learning processing to establish a trained model Ma corresponding to a musical genre, multiple pieces of training data TDa are used that include input data Xat for the musical genre. For example, a set of pieces of training data TDa is prepared for each of the different musical genres. The trained model Ma is established by the learning processing for each of the different musical genres. “Musical genre” means a particular classification (type) of music. Examples of a musical genre are rock, pop, jazz, trance, and hip hop.

The information device 80 selectively acquires one of the trained models Ma included in the information processing system 40 via the communication network 90. The information device 80 may acquire one of the trained models Ma that corresponds to a particular musical genre from the information processing system 40. For example, the information device 80 refers to a genre tag included in the audio signal S1 (music file) and acquires a trained model Ma, which corresponds to a musical genre represented by the genre tag, from the information processing system 40. “Genre tag” is tag information indicative of a particular musical genre applied to a music file such as a MP3 file or an advanced audio coding (AAC) file. Alternatively, the information device 80 may estimate the musical genre of a piece of music by analyzing the audio signal S1. To estimate the musical genre, a known technique may be used. The information device 80 acquires the trained model Ma corresponding to the estimated musical genre from the information processing system 40. The trained model Ma acquired from the information processing system 40 is stored in the storage device 82. The trained model Ma is used by the selector 1133 to acquire the degree of similarity Qn.

As will be understood from the above description, the sixth embodiment provides the same effects as the first, second, third, fourth, and fifth embodiments. In the sixth embodiment, the trained model Ma is established for each musical genre. Accordingly, compared to a configuration in which a common trained model Ma is used regardless of a musical genre, the sixth embodiment has an advantage in that a highly accurate similarity Qn is obtained.

In the above description, a configuration is described in which the information processing system 40 includes a plurality of trained models Ma that correspond to different musical genres. Alternatively, the information device 80 may acquire the plurality of trained models Ma from the information processing system 40 and includes the plurality of trained models Ma. In this case, the plurality of trained models Ma are stored in the storage device 82 of the information device 80. The audio analyzer 113 selectively uses one of the plurality of trained models Ma to calculate the degree of similarity Qn.

### G: Modifications

This disclosure is not limited to the embodiments described above, and each of the embodiments described above may be variously modified. The following are examples of modifications of the embodiments described above. Two or more modifications freely selected from the following modifications may be combined as long as no conflict arises from such combination.

(1) In each of the foregoing embodiments, the audio signal S2 corresponding to the musical instrument indicated by the user is separated from the plurality of audio components, which correspond to the different musical instruments, included in the audio signal S1. However, audio components of singing of a piece of music may be separated from the plurality of audio components.

(2) In each of the foregoing embodiments, a correlation between the reference rhythm pattern Zn and the analysis rhythm pattern Y is used as a degree of similarity Qn. However, the selector 1133 may calculate, as a degree of similarity Qn, a distance between the reference rhythm pattern Zn and the analysis rhythm pattern Y. In this configuration, the greater a similarity between the reference rhythm pattern Zn and the analysis rhythm pattern Y, the lesser a numerical value represented by the degree of similarity Qn. A distance between the reference rhythm pattern Zn and the analysis rhythm pattern Y may be a distance indicator, such as a cosine distance or KL divergence.

(3) In each of the foregoing embodiments, the selector 1133 selects, from among the reference signals R1 to RN, two or more reference signals Rn for each of which the reference rhythm pattern Zn is similar to the analysis rhythm pattern Y. However, the selector 1133 may select, from among the reference signals R1 to RN, one reference signal Rn for which the reference rhythm pattern Zn is similar to the analysis rhythm pattern Y. Thus, the selector 1133 selects, based on the target musical instrument (target timbre) indicated by the instruction data D and on the audio signal S1 including the plurality of audio components, at least one reference signal Rn from among the reference signals R1 to RN. The at least one reference signal Rn has an intensity with a temporal change. The temporal change in the intensity of the at least one reference signal Rn is represented by the reference rhythm pattern Zn. The plurality of audio components include audio components corresponding to the target musical instrument (target timbre). The audio components corresponding to the target musical instrument (target timbre) have an intensity with a temporal change. The temporal change in the intensity of the audio components corresponding to the target musical instrument (target timbre) is represented by the analysis rhythm pattern Y. The reference rhythm pattern Zn is similar to the analysis rhythm pattern Y.

(4) In each of the foregoing embodiments, the reference signal Rn is typically representative of audio of a single musical instrument. However, the reference signal Rn may be representative of audio of two or more different types of musical instruments.

(5) In the second embodiments, the analyzer 1132 sets elements of one or more rows of coefficients corresponding to musical instruments other than the target musical instrument to be zero. However, the analyzer 1132 need not set the elements of the one or more rows of coefficients yin to be zero.

(6) In each of the foregoing embodiments, the information processing system 40 establishes the trained model M. However, the functions of the information processing system 40 (the training data acquirer 51 and the training processor 52) may be implemented by the information device 80 according to the fourth embodiment. In each of the foregoing embodiments, the information processing system 40 generates the basis matrix B and the reference rhythm patterns Zn. However, the functions of the information processing system 40 to generate the basis matrix B and the reference rhythm patterns Zn may be implemented by the information device 80 according to the fourth embodiment.

(7) In each of the foregoing embodiments, an example of the trained model M is a deep neural network. However, the trained model M is not limited to a deep neural network. A statistical estimation model, such as Hidden Markov Model (HMM) or Support Vector Machine (SVM) may be used as trained model M. In each of the foregoing embodiments, an example of the learning processing Sc is supervised machine learning using the multiple pieces of training data TD. However, the trained model M may be established by unsupervised machine learning in which the multiple pieces of training data TD are not required. Alternatively, the trained model M may be established by reinforcement learning in which cumulative reward is maximized. In an example of the unsupervised machine learning, known clustering may be used.

(8) The functions (the acquirer 111, the instruction receiver 112, the audio analyzer 113, the presenter 114, and the reproduction controller 115) described in the foregoing embodiments are implemented by cooperation of one or more processors, which include the controller (11 or 81), and the program stored in the storage device (12 or 82). The program may be provided in a form stored in a computer-readable recording medium and the program may be installed in a computer. The recording medium may be a non-transitory recording medium. An example of the non-transitory recording medium is an optical recording medium (an optical disk) such as a compact disk read-only memory (CD-ROM). The non-transitory recording medium may also include a recording medium of any known form, such as a semiconductor recording medium or a magnetic recording medium. The non-transitory recording medium, which includes any recording medium except for a transitory, propagating signal, does not exclude a volatile recording medium. The non-transitory recording medium may be a storage apparatus in a distribution apparatus that stores a computer program for distribution via a communication network.

(9) In each of the foregoing embodiments, the degree of similarity Qn is calculated by comparing the analysis rhythm pattern Y with the reference rhythm pattern Zn. However, calculation for the degree of similarity Qn is not limited to the examples described above. The selector 1133 may determine the degree of similarity Qn by searching a table for a degree of similarity Qn that corresponds to a combination (hereinafter referred to as “feature value data”) of a feature extracted from the audio signal S2 and a feature extracted from the reference signal Rn. The table stores a degree of similarity Qn for each piece of feature value data. The feature of the audio signal S2 may be data indicative of a time series of frequency characteristics related to the audio signal S2. The feature of the reference signal Rn may be data indicative of a time series of frequency characteristics related to the reference signal Rn. Each feature may be data indicative of a time series of frequency characteristics such as Mel-frequency cepstrum coefficient (MFCC), Mel-scale log spectrum (MSLS), or Constant-Q transform (CQT).

(10) In the fifth embodiment, the trained model Ma configured to generate the degree of similarity Qn from the input data Xa is constituted of a deep neural network. However, the trained model Ma is not limited to a deep neural network. A statistical estimation model, such as Hidden Markov Model (HMM) or Support Vector Machine (SVM) may be used as trained model Ma. Examples of the trained model Ma will be described below.

### (10-1) HMM

HMM is a statistical estimation model in which hidden states, which correspond to different numerical values of a degree of similarity Qn, are connected to each other. A piece of feature value data, which is a combination of a feature extracted from the audio signal S2 and a feature extracted from the reference signal Rn, is input into the HMM one after another. The feature value data may be data for a time period that corresponds to one measure of a piece of music.

The selector 1133 inputs a time series of pieces of feature value data into the trained model Ma constituted of the HMM described above. Under condition that the pieces of feature value data are observed, the selector 1133 estimates a time series of degree of similarity Qn having a maximum likelihood by using the HMM. To estimate the degree of similarity Qn, dynamic programming such as a Viterbi algorithm is used, for example.

The HMM is established by supervised machine learning using multiple pieces of training data including the degree of similarity Qn. In machine learning, transitional probability and output probability for each of the hidden states are repeatedly updated such that a time series of degrees of similarity Qn having a maximum likelihood is output for a time series of pieces of feature value data.

### (10-2) SVM

An SVM is provided for every combination for selecting two numerical values from among multiple numerical values that can be taken by the degree of similarity Qn. The SVM, which corresponds to a combination of two numerical values, establishes a hyperplane in multi-dimensional space by machine learning. The hyperplane is a boundary surface that divides a first space from a second space. The first space includes distributed pieces of feature value data that correspond to one of the two numerical values. The second space includes distributed pieces of feature value data that correspond to the other of the two numerical values. The trained model according to this modification is constituted of multiple SVMs (multi-class SVM) that correspond to all the combinations for selecting two numerical values from among the multiple numerical values that can be taken by the degree of similarity Qn.

The selector 1133 inputs the feature value data into each of the multiple SVMs. The SVM, which corresponds to each of the combinations, selects one of the two numerical values corresponding to the combination based on whether the feature value data is included in the first space or in the second space. Thus, the multiple SVMs corresponding to the different combinations each select one of the two numerical values. The selector 1133 selects one numerical value, which has the largest number of selections by the respective multiple SVMs, as a degree of similarity Qn.

As will be understood from the above description, the selector 1133 according to this modification functions as an element configured to input the feature value data into a trained model to cause the trained model to output a degree of similarity Qn that is an indicator of a degree of similarity between a feature extracted from the audio signal S2 and a feature extracted from the reference signal Rn.

(11) In the fifth embodiment, an example of the learning processing is supervised machine learning using the multiple pieces of training data TDa. However, the trained model Ma may be established by reinforcement learning in which cumulative reward is maximized. For example, the training processor 52a sets a reward function to “+1” when the degree of similarity Q, which is output from the provisional model Ma0 receiving the input data Xat of a piece of training data TDa, corresponds to the degree of similarity Qnt of the piece of training data TDa. The training processor 52a sets the reward function to “−1” when the degree of similarity Q does not correspond to the degree of similarity Qnt. The training processor 52a establishes the trained model Ma by repeatedly updating the multiple variables of the provisional model Ma0 so that the sum of the reward functions set for the multiple pieces of training data TDa is maximized.

(12) In the first embodiment, by using the trained model M that is trained to learn a relationship between (i) input data X that includes the audio signal S1 and the instruction data D, and (ii) an audio signal S2, an audio signal S2 corresponding to the input data X is generated. However, the configuration and the method of generating the audio signal S2 from input data X are limited to those of the foregoing embodiment. For example, the separator 1131 may generate the audio signal S2 by using a reference table in which multiple audio signals S2 have a one-to-one correspondence with multiple different pieces of input data X. The reference table is a data table in which associations between the multiple pieces of input data X and the multiple audio signals S2 are registered. The reference table is, for example, stored in the storage device 12. The separator 1131 searches the reference table for a piece of input data X that corresponds to a combination of the audio signal S1 and the instruction data D. The separator 1131 acquires an audio signal S2, which corresponds to the piece of input data X, from among the multiple audio signals S2 in the reference table.

(13) In the fifth or sixth embodiment, by using the trained model Ma that is trained to learn a relationship between (i) input data Xa that includes an analysis rhythm pattern Y and a reference rhythm pattern Zn, and (ii) a degree of similarity Qn, a degree of similarity Qn corresponding to input data Xa is generated. However, the configuration and the method of generating the degree of similarity Qn from input data Xa are limited to those of the foregoing embodiments. For example, the selector 1133 may generate the degree of similarity Qn by using a reference table in which multiple degrees of similarity Qn have a one-to-one correspondence with multiple different pieces of input data Xa. The reference table is a data table in which associations between the multiple pieces of input data Xa and the multiple degrees of similarity Qn are registered. The reference table is, for example, stored in the storage device 12. The selector 1133 searches the reference table for a piece of input data Xa that corresponds to a combination of the analysis rhythm pattern Y and the reference rhythm pattern Zn. The selector 1133 acquires a degree of similarity Qn, which corresponds to the piece of input data Xa, from among the multiple degrees of similarity Qn in the reference table.

(14) In each of the foregoing embodiments, the instruction receiver 112 receives the instruction indicative of the target musical instrument from the user. However, the instruction receiver 112 may receive the instruction indicative of the target musical instrument from an object other than the user. The instruction receiver 112 may receive the instruction indicative of the target musical instrument from an external device. The instruction receiver 112 may receive the instruction indicative of the target musical instrument that is generated by the electronic musical instrument 10.

(15) In each of the foregoing embodiments, an example of the electronic musical instrument 10 is an electronic keyboard instrument. However, the electronic musical instrument 10 is not limited to an electronic keyboard instrument. The electronic musical instrument 10 may be an electronic stringed instrument (for example, an electronic guitar or an electronic violin), an electronic drum kit, or an electronic wind instrument (for example, an electronic saxophone, an electronic clarinet, or an electronic flute).

### F: Supplemental Notes

The following configurations are derivable from the foregoing embodiments.

An audio analysis system according to one aspect (first aspect) includes: at least one memory configured to store instructions; and at least one processor configured to execute the instructions to: receive an instruction indicative of a target timbre; acquire a first audio signal containing a plurality of audio components corresponding to different timbres; and select at least one reference signal from among a plurality of reference signals respectively representative of different pieces of audio based on the target timbre and the first audio signal, in which: the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern. According to this aspect, one or more reference signals for which the reference rhythm pattern is similar to the analysis rhythm pattern for the target timbre are selected from among the plurality of reference signals. As a result, an amount of time required by the user in finding a rhythm pattern for a musical instrument indicated by the user is reduced, and efficacy in creation of a piece of music or in practice of a piece of music is increased.

In a specific example (second aspect) of the first aspect, the at least one processor is configured to execute the instructions to: separate, from the first audio signal, a second audio signal representative of the audio components corresponding to the target timbre; calculate the analysis rhythm pattern for the second audio signal; and select, from the plurality of reference signals, the at least one reference signal for which at least one reference rhythm pattern is similar to the calculated analysis rhythm pattern.

In a specific example (third aspect) of the second aspect, the at least one processor is configured to execute the instructions to cause a trained model to output the second audio signal by inputting into the trained model a combination of the first audio signal and instruction data indicative of the target timbre, the trained model is trained to learn a relationship between (i) a combination of a first training audio signal and training instruction data indicative of a timbre, and (ii) a second training audio signal, the first training audio signal includes the plurality of audio components corresponding to the different timbres, and the second training audio signal is representative of audio components corresponding to the timbre indicated by the training instruction data from among the plurality of audio components included in the first training audio signal.

In a specific example (fourth aspect) of the second or third aspect, the at least one processor is configured to execute the instructions to calculate, as the analysis rhythm pattern, a coefficient matrix from the second audio signal by non-negative matrix factorization using a basis matrix representative of a plurality of frequency characteristics corresponding to the different timbres.

In a specific example (fifth aspect) of the second aspect, the at least one processor is configured to execute the instructions to: calculate a coefficient matrix from the first audio signal by non-negative matrix factorization using a basis matrix representative of a plurality of frequency characteristics of the different timbres; and generate the analysis rhythm pattern by setting to zero first elements included in the calculated coefficient matrix, the first elements are elements of first rows of coefficients among a plurality of rows of coefficients included in the calculated coefficient matrix, and the first rows of coefficients respectively correspond to timbres other than the target timbre.

In a specific example (sixth aspect) of any of the second through fifth aspects, the at least one processor is configured to execute the instructions to: calculate a degree of similarity between the reference rhythm pattern and the analysis rhythm pattern for each of the plurality of reference signals; and select the at least one reference signal from among the plurality of reference signals based on the degree of similarity between the reference rhythm pattern and the analysis rhythm pattern for each of the plurality of reference signals. According to this aspect, at least one reference signal is appropriately selected based on a degree of similarity between the reference rhythm pattern for each of the plurality of reference signals and the analysis rhythm pattern for the target timbre.

In a specific example (seventh aspect) of the sixth aspect, the at least one processor is configured to execute the instructions to cause a trained model to output the degree of similarity by inputting input data into the trained model, the input data includes the reference rhythm pattern and the analysis rhythm pattern, the trained model is trained to learn a relationship between training input data and a training degree of similarity, the training input data includes a training reference rhythm pattern and a training analysis rhythm pattern, and the training degree of similarity is a degree of similarity between the training reference rhythm pattern and the training analysis rhythm pattern.

In a specific example (eighth aspect) of the seventh aspect, the trained model is a trained model corresponding to a particular musical genre among a plurality of trained models respectively corresponding to a plurality of different musical genres.

In a specific example (ninth aspect) of the eighth aspect, a trained model, among the plurality of trained models, corresponding to a first musical genre, among the plurality of different musical genres, is established by machine learning using a plurality pieces of training data corresponding to the first musical genre.

In a specific example (tenth aspect) of any of the seventh through ninth aspects, the trained model includes: a first model including a convolutional neural network, the first model configured to generate feature data from the input data; and a second model including a recurrent neural network, the second model configured to generate the degree of similarity from the feature data.

In a specific example (eleventh aspect) of any of the second through fifth aspects, the reference rhythm pattern includes a first plurality of rows of respectively coefficients corresponding to the different timbres, the analysis rhythm pattern includes a second plurality of rows of coefficients respectively corresponding to the different timbres, and the at least one processor is configured to execute the instructions to: generate, for each reference rhythm pattern, a compressed reference rhythm pattern by compressing a plurality of first elements in each of the first plurality of rows of coefficients in the reference rhythm pattern as an average or a sum of the plurality of first elements; generate a compressed analysis rhythm pattern by compressing a plurality of second elements in each of the second plurality of rows of coefficients in the analysis rhythm pattern as an average or a sum of the plurality of second elements; calculate, for each compressed reference rhythm pattern, a degree of similarity between the compressed reference rhythm pattern and the compressed analysis rhythm pattern; and select, based on the degree of similarity for each compressed reference rhythm pattern, the at least one reference signal from among the plurality of reference signals.

In a specific example (twelfth aspect) of any of the sixth through eleventh aspects, the at least one reference signal includes at least two reference signals, and the at least one processor is configured to execute the instructions to cause a display to display information on the at least two reference signals in an order based on the degree of similarity. According to this aspect, the user can recognize an order of the plurality of reference signals, the order being based on the similarity between the reference rhythm pattern for each of the plurality of reference signals and the analysis rhythm pattern for the target timbre. Thus, the user can create a piece of music or practice playing a piece of music in the order of the plurality of reference signals, for example.

In a specific example (thirteenth aspect) of any of the second through twelfth aspects, the at least one processor is configured to execute the instructions to: calculate the analysis rhythm pattern for each of unit portions of the second audio signal obtained by dividing the second audio signal on a time-axis; and select the at least one reference signal for each of the unit portions of the second audio signal.

In a specific example (fourteenth aspect) of any of the first through eleventh aspects, the at least one processor is configured to execute the instructions to display the selected at least one reference signal. According to this aspect, a user can visually recognize the selected at least one reference signal.

An electronic musical instrument according to one aspect (fifteenth aspect) includes: at least one memory configured to store instructions; and at least one processor configured to execute the instructions to: receive an instruction indicative of a target timbre; acquire a first audio signal containing a plurality of audio components corresponding to different timbres; select at least one reference signal from among a plurality of reference signals respectively representative of different pieces of audio based on the target timbre and the first audio signal, and cause a playback system to emit a sound represented by the at least one reference signal and to emit a sound corresponding to a playing of a piece of music by a user, in which: the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

A computer-implemented audio analysis method according to one aspect (sixteenth aspect) includes: receiving an instruction indicative of a target timbre; acquiring a first audio signal containing a plurality of audio components corresponding to different timbres; and, selecting at least one reference signal from among a plurality of reference signals respectively representative of different pieces of audio based on the target timbre and the first audio signal, in which the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

A non-transitory computer-readable recording medium according to one aspect (seventeenth aspect) is a non-transitory computer-readable recording medium storing a program executable by at least one processor to execute an audio analysis method, and the method includes: receiving an instruction indicative of a target timbre; acquiring a first audio signal containing a plurality of audio components corresponding to different timbres; and, selecting at least one reference signal from among a plurality of reference signals respectively representative of different pieces of audio based on the target timbre and the first audio signal, in which the at least one reference signal has an intensity with a temporal change, the temporal change in the intensity of the at least one reference signal is represented by a reference rhythm pattern, the plurality of audio components include audio components corresponding to the target timbre, the audio components corresponding to the target timbre have an intensity with a temporal change, the temporal change in the intensity of the audio components corresponding to the target timbre is represented by an analysis rhythm pattern, and the reference rhythm pattern is similar to the analysis rhythm pattern.

### DESCRIPTION OF REFERENCE SIGNS

10 . . . electronic musical instrument, 11, 81 . . . controller, 12, 82 . . . storage device, 13 . . . communication device, 14, 84 . . . operation device, 15 . . . playing input device, 16 . . . audio source, 17 . . . sound emitting device, 18 . . . playback system, 19, 83 . . . display, 40 . . . information processing system, 90 . . . communication network, 100 . . . playing system, 111 . . . acquirer, 112 . . . instruction receiver, 113 . . . audio analyzer, 114 . . . presenter, 115 . . . reproduction controller, 1131 . . . separator, 1132 . . . analyzer, 1133 . . . selector, D . . . instruction data, Dt . . . training instruction data, M . . . trained model, O . . . observation matrix, Qn (Q1 to QN) . . . degree of similarity, Rn (R1 to RN) . . . reference signal, S1, S2 . . . audio signal, S1t, S2t . . . training audio signal, T . . . unit portion, Y . . . analysis rhythm pattern, Zn (Z1 to Zn) . . . reference rhythm pattern.

What is claimed is:

1. An audio analysis system comprising:
at least one memory configured to store instructions; and
at least one processor configured to execute the instructions to:
receive an instruction indicative of a target timbre;
acquire a first audio signal containing a plurality of audio components corresponding to different timbres; and
select at least one reference signal from among a plurality of reference signals respectively representative of different pieces of audio based on the target timbre and the first audio signal,
wherein:
the at least one reference signal has an intensity with a temporal change,
the temporal change in the intensity of the at least one reference signal is represented by a reference rhythm pattern,
the plurality of audio components include audio components corresponding to the target timbre,
the audio components corresponding to the target timbre have an intensity with a temporal change,
the temporal change in the intensity of the audio components corresponding to the target timbre is represented by an analysis rhythm pattern, and
the reference rhythm pattern is similar to the analysis rhythm pattern.

2. The audio analysis system according to claim 1, wherein the at least one processor is configured to execute the instructions to:
separate, from the first audio signal, a second audio signal representative of the audio components corresponding to the target timbre;
calculate the analysis rhythm pattern for the second audio signal; and
select, from the plurality of reference signals, the at least one reference signal for which at least one reference rhythm pattern is similar to the calculated analysis rhythm pattern.

3. The audio analysis system according to claim 2, wherein:
the at least one processor is configured to execute the instructions to cause a trained model to output the second audio signal by inputting into the trained model a combination of the first audio signal and instruction data indicative of the target timbre,
the trained model is trained to learn a relationship between (i) a combination of a first training audio signal and training instruction data indicative of a timbre, and (ii) a second training audio signal,
the first training audio signal includes the plurality of audio components corresponding to the different timbres, and
the second training audio signal is representative of audio components corresponding to the timbre indicated by the training instruction data among the plurality of audio components included in the first training audio signal.

4. The audio analysis system according to claim 2, wherein the at least one processor is configured to execute the instructions to calculate, as the analysis rhythm pattern, a coefficient matrix from the second audio signal by non-negative matrix factorization using a basis matrix representative of a plurality of frequency characteristics corresponding to the different timbres.

5. The audio analysis system according to claim 2, wherein:
the at least one processor is configured to execute the instructions to:
calculate a coefficient matrix from the first audio signal by non-negative matrix factorization using a basis matrix representative of a plurality of frequency characteristics of the different timbres; and
generate the analysis rhythm pattern by setting to zero first elements included in the calculated coefficient matrix,
the first elements are elements of first rows of coefficients among a plurality of rows of coefficients included in the calculated coefficient matrix, and
the first rows of coefficients respectively correspond to timbres other than the target timbre.

6. The audio analysis system according to claim 2, wherein the at least one processor is configured to execute the instructions to:
calculate a degree of similarity between the reference rhythm pattern and the analysis rhythm pattern for each of the plurality of reference signals; and
select the at least one reference signal from among the plurality of reference signals based on the degree of similarity between the reference rhythm pattern and the analysis rhythm pattern for each of the plurality of reference signals.

7. The audio analysis system according to claim 6, wherein:
the at least one processor is configured to execute the instructions to cause a trained model to output the degree of similarity by inputting input data into the trained model,
the input data includes the reference rhythm pattern and the analysis rhythm pattern,
the trained model is trained to learn a relationship between training input data and a training degree of similarity,
the training input data includes a training reference rhythm pattern and a training analysis rhythm pattern, and
the training degree of similarity is a degree of similarity between the training reference rhythm pattern and the training analysis rhythm pattern.

8. The audio analysis system according to claim 7, wherein the trained model is a trained model corresponding to a particular musical genre among a plurality of trained models respectively corresponding to a plurality of different musical genres.

9. The audio analysis system according to claim 8, wherein a trained model, among the plurality of trained models, corresponding to a first musical genre, among the plurality of different musical genres, is established by machine learning using a plurality pieces of training data corresponding to the first musical genre.

10. The audio analysis system according to claim 7, wherein the trained model includes:
a first model including a convolutional neural network, the first model configured to generate feature data from the input data; and
a second model including a recurrent neural network, the second model configured to generate the degree of similarity from the feature data.

11. The audio analysis system according to claim 2, wherein:
the reference rhythm pattern includes a first plurality of rows of coefficients respectively corresponding to the different timbres,
the analysis rhythm pattern includes a second plurality of rows of coefficients respectively corresponding to the different timbres, and
the at least one processor is configured to execute the instructions to:
generate, for each reference rhythm pattern, a compressed reference rhythm pattern by compressing a plurality of first elements in each of the first plurality of rows of coefficients in the reference rhythm pattern as an average or a sum of the plurality of first elements;
generate a compressed analysis rhythm pattern by compressing a plurality of second elements in each of the second plurality of rows of coefficients in the analysis rhythm pattern as an average or a sum of the plurality of second elements;
calculate, for each compressed reference rhythm pattern, a degree of similarity between the compressed reference rhythm pattern and the compressed analysis rhythm pattern; and
select, based on the degree of similarity for each compressed reference rhythm pattern, the at least one reference signal from among the plurality of reference signals.

12. The audio analysis system according to claim 6, wherein:
the at least one reference signal includes at least two reference signals, and
the at least one processor is configured to execute the instructions to cause a display to display information on the at least two reference signals in an order based on the degree of similarity.

13. The audio analysis system according to claim 2, wherein the at least one processor is configured to execute the instructions to:
calculate the analysis rhythm pattern for each of unit portions of the second audio signal obtained by dividing the second audio signal on a time-axis; and
select the at least one reference signal for each of the unit portions of the second audio signal.

14. The audio analysis system according to claim 1, wherein the at least one processor is configured to execute the instructions to display the selected at least one reference signal.

15. An electronic musical instrument comprising:
at least one memory configured to store instructions; and
at least one processor configured to execute the instructions to:
receive an instruction indicative of a target timbre;
acquire a first audio signal containing a plurality of audio components corresponding to different timbres;
select at least one reference signal from among a plurality of reference signals respectively representative of different pieces of audio based on the target timbre and the first audio signal, and
cause a playback system to emit a sound represented by the at least one reference signal and to emit a sound corresponding to a playing of a piece of music by a user,
wherein:
the at least one reference signal has an intensity with a temporal change,
the temporal change in the intensity of the at least one reference signal is represented by a reference rhythm pattern,
the plurality of audio components include audio components corresponding to the target timbre,
the audio components corresponding to the target timbre have an intensity with a temporal change,
the temporal change in the intensity of the audio components corresponding to the target timbre is represented by an analysis rhythm pattern, and
the reference rhythm pattern is similar to the analysis rhythm pattern.

16. A computer-implemented audio analysis method comprising:
receiving an instruction indicative of a target timbre;
acquiring a first audio signal containing a plurality of audio components corresponding to different timbres; and,
selecting at least one reference signal from among a plurality of reference signals respectively representative of different pieces of audio based on the target timbre and the first audio signal, wherein:
the at least one reference signal has an intensity with a temporal change,
the temporal change in the intensity of the at least one reference signal is represented by a reference rhythm pattern,
the plurality of audio components include audio components corresponding to the target timbre,
the audio components corresponding to the target timbre have an intensity with a temporal change,
the temporal change in the intensity of the audio components corresponding to the target timbre is represented by an analysis rhythm pattern, and
the reference rhythm pattern is similar to the analysis rhythm pattern.
